(19) United States
(12) Patent Application Publication
(10) Pub. No.: US 2014/0264111 A1
(43) Pub. Date: Sep. 18, 2014

(54) AUTOMATIC VALVE ACTUATOR SYSTEMS

(71) Applicant: designPORT, Inc., Salem, OR (US)

(72) Inventors: Douglas Roy Porter, Salem, OR (US); Ken Courian, Portland, OR (US)

(73) Assignee: designPORT, Inc., Salem, OR (US)

(21) Appl. No.: 14/213,618

(22) Filed: Mar. 14, 2014

Related U.S. Application Data
(60) Provisional application No. 61/798,885, filed on Mar. 15, 2013.
(60) Provisional application No. 61/949,981, filed on Mar. 7, 2014.

(51) Int. Cl. F16K 17/36

(52) U.S. Cl. CPC F16K 17/36
USPC 251/129.03

(57) ABSTRACT

Automatic valve actuator apparatus and valve actuator assemblies are disclosed. The automatic valve actuator apparatus may include a sensor assembly configured to detect a condition and transmit a sensor signal indicating detection of the condition, and a valve actuator assembly configured to be attached to the manual valve and to move the manual valve between open and closed positions. The automatic valve actuator apparatus may additionally include a control assembly configured to receive the sensor signal and to transmit a first control signal to the valve actuator assembly based, at least in part, on the sensor signal. The valve actuator assembly may be further configured to receive the first control signal from the control assembly and to move the manual valve toward the closed position in response to receiving the first control signal.

### CROSS-REFERENCE TO RELATED APPLICATIONS

This application claims the benefit of U.S. Provisional Patent Application Ser. No. 61/798,885, which was filed on Mar. 15, 2013, and of U.S. Provisional Patent Application Ser. No. 61/949,981, which was filed on Mar. 7, 2014. The complete disclosures of the above applications are hereby incorporated by reference for all purposes.

### BACKGROUND OF THE DISCLOSURE

Manual shutoff valves are commonly used and installed in piping systems that transport fluids, such as water, natural gas, gasoline, diesel, and/or other chemicals. When there is a need to stop flow in the piping systems, a person must be alerted of the need to stop the flow, find the proper manual shutoff valve, and manipulate that valve correctly to stop the flow. For example, when there is a natural gas leak (such as caused by a seismic event), a person must know about the leak, find the proper manual shutoff valve for natural gas, and turn that valve properly to stop the flow of natural gas. Additionally, when there is a water leak from broken and/or corroded water piping, a person must know about the leak, find the proper manual shutoff valve for water, and turn that valve properly to stop the flow of water.

Alternatively, automatic valve actuators may be installed to detect the need to prevent flow in piping systems and to actuate already-installed manual shutoff valves to stop flow in those piping systems. Examples of shutoff valves and automatic valve actuators are described in U.S. Pat. Nos. 4,979,528; 5,038,820; 5,143,110; and 6,209,576. The complete disclosures of the above patents are hereby incorporated by reference for all purposes.

### SUMMARY OF THE DISCLOSURE

An automatic actuator apparatus for a manual valve may include a sensor assembly configured to detect a condition and transmit a sensor signal indicating detection of the condition, and a valve actuator assembly configured to be attached to the manual valve and to move the manual valve between open and closed positions. The automatic actuator apparatus may additionally include a control assembly configured to receive the sensor signal and to transmit a first control signal to the valve actuator assembly based, at least in part, on the sensor signal. The valve actuator assembly may be further configured to receive the first control signal from the control assembly and to move the manual valve toward the closed position in response to receiving the first control signal.

A valve actuator and control apparatus for a manual valve may include a valve actuator assembly configured to be attached to the manual valve and to move the manual valve between open and closed positions. The valve actuator assembly may include a gear assembly configured to be attached to the manual valve; and a motor operatively connected to the gear assembly to move the manual valve between open and closed positions. The valve actuator and control apparatus may additionally include a control assembly configured to receive a sensor signal and to transmit a control signal to the valve actuator assembly based, at least in part, on the sensor signal. The valve actuator assembly may be further configured to receive the control signal from the control assembly and to move the manual valve toward the closed position in response to receiving the control signal.

An automatic actuator apparatus for a manual valve may include a sensor assembly configured to detect water and transmit a sensor signal indicating detection of water, and a valve actuator assembly. The valve actuator assembly may include a gear assembly configured to be attached to the manual valve, and a motor operatively connected to the gear assembly and configured to move the manual valve between open and closed positions. The automatic actuator apparatus may additionally include a control assembly configured to receive the sensor signal and to transmit a control signal to the motor based, at least in part, on the sensor signal. The motor may be further configured to receive the control signal from the control assembly and to move the manual valve toward the closed position in response to receiving the control signal. The automatic actuator apparatus may further include a manual override assembly configured to disconnect the motor from the gear assembly to allow a user to move the manual valve between the open and closed positions.

### BRIEF DESCRIPTION OF THE DRAWINGS

FIG. 1 is a block diagram of an example of an automatic valve actuator system, showing an example of a valve actuator assembly.

FIG. 2 is an isometric view of an example of a valve actuator assembly of FIG. 1, shown attached to a wall and a first valve.

FIG. 3 is a partial view of a valve actuator assembly of FIG. 2, shown attached to a second valve.

FIG. 4 is an exploded view of the valve actuator assembly of FIG. 2 showing a connector for the first valve, and shown without zip ties (or other structure) for attaching the connector to a handle of the first valve.

FIG. 5 is a sectional view of the valve actuator assembly of FIG. 2 taken along lines 5-5 in FIG. 2.

FIG. 6 is a partial view of the valve actuator assembly of FIG. 2, shown without the housing and with some of the components in sectional view to demonstrate position of those components when the valve actuator assembly in the motor driven mode.

FIG. 7 is a partial view of the valve actuator assembly of FIG. 2, shown without the housing and some of the components in sectional view to demonstrate position of those components when the valve actuator assembly in the manual override mode.

FIG. 8 is an isometric view of the valve actuator assembly of FIG. 2, shown attached to a wall via one or more supporting members and to a third valve.

FIG. 9 is an isometric view of the valve actuator assembly of FIG. 2, shown attached to a wall and a fourth valve via one or more flexible connectors.

### DETAILED DESCRIPTION OF THE DISCLOSURE

FIG. 1 shows an example of an automatic valve actuator system 20, which may include any suitable structure configured to operate already-installed manual valves (such as manual shutoff valves) based on one or more sensed conditions. The automatic valve actuator system may be configured to be installed without having to add to, alter, or otherwise change existing plumbing. For example, the system may attach onto existing and working plumbing with no changes to wetted parts of that plumbing. For example, the automatic valve actuator system may include a sensor subsystem 22, a valve actuator assembly 24, and a control subsystem 26.

Although the automatic valve actuator system is shown to include discrete components, one or more of those components may be incorporated into other component(s). For example, although control subsystem is shown to be a component separate from the valve actuator assembly, the control subsystem may be incorporated with the valve actuator assembly. Additionally, one or more components of the automatic valve actuator system may be remote and/or spaced from the other components. For example, sensor subsystem may be remote from the control subsystem and/or valve actuator assembly.

The sensor subsystem may include any suitable structure configured to detect and/or measure one or more suitable variables and/or parameters and to generate one or more signals based on the detected and/or measured variable(s) and/or parameter(s). The variable(s) and/or parameter(s) detected and/or measured may be in the piping systems, in one or more other systems, and/or one or more ambient conditions. For example, the sensor subsystem may detect mass, volume, flow, temperature, proper acceleration, noise (or sound waves), electrical current, pressure, refractive index, thermal conductivity, density, viscosity, optical absorbance, electrical conductivity, and/or other suitable variable(s) and/or parameter(s).

For example, the sensor subsystem may include a sensor assembly 28 having one or more sensors configured to detect pressure, temperature, flowrate, volume, and/or other parameters. In one example, the sensor(s) may detect the presence of water based on electrical conductivity and/or other parameter(s). In another example, the sensor(s) may detect a leak of any suitable fluid(s) based on a drop in pressure and/or other parameter(s). In a further example, the sensor(s) may detect an earthquake's sound wave.

Sensor subsystem may communicate with the control subsystem via one or more communication linkages that may be wired or wireless for one-way or two-way communication. In some examples, sensor subsystem may include a transmitting assembly 30 configured to transmit the generated signal(s) to the control subsystem.

Valve actuator assembly 24 may include any suitable structure configured to actuate and/or operate any suitable valve(s) based on one or more signals from the control subsystem. The valve actuator assembly may be configured to actuate a gate valve, a ball valve, and/or other suitable valve(s). The valve actuator assembly may, for example, include a clamping assembly 32, a support assembly 34, a motion assembly 36, and a manual override assembly 38.

Clamping assembly 32 may include any suitable structure configured to attach to a valve. “Valve,” as used herein refers to any device that regulates, directs, or controls the flow of a fluid by opening, closing, partially obstructing various passageways. For example, valves may include ball valves, gate valves, butterfly valves, globe valves, needle valves, plug valves, spherical valves, fixed cone valves, etc. A valve may have a valve stem having opposed sides, such as flat (or generally flat or planar) opposed sides.

In some examples, the clamping assembly may be configured to apply a compressive force on opposed sides of the valve stem to connect to the valve stem. For example, the clamping assembly may include a pair of jaw clamps to clamp on the flat opposed sides of a valve stem. The jaw clamps may be formed as a single component or may be discrete components that are movably connected (such as pivotably connected). The clamping assembly may further include a connector element, such as a tightening bolt or screw, configured to adjust and/or secure the jaw clamps on the opposed sides of a valve stem and/or to accommodate a variety of different sized valve stems.

Alternatively, or additionally, clamping assembly may include a valve adapter configured to receive a valve stem. The valve adapter may be configured to receive a particular sized valve stem and/or may be adjustable to receive various sizes of valve stems. In some examples, the clamping assembly may include a base adapter and one or more valve adapters that are configured to attach to the base adapter to accommodate a variety of valve stems. For example, one or more valve adapters may be configured to nest within the base adapter.

Support assembly 34 may include any suitable structure configured to attach to one or more portions of the piping system adjacent to the clamped valve. For example, the support assembly may include spaced piping attachment structures configured to attach to the piping, valve body, and/or other component(s) adjacent to the clamped valve. In some examples, the clamping assembly may be disposed between the piping attachment structures. In other examples, valve actuator assembly may not include a support assembly 34.

Motion assembly 36 may include any suitable structure configured to actuate, operate, and/or move the valve stem attached to the clamping assembly based on one or more signals from the control subsystem. For example, the motion assembly may include one or more motor(s) 40 configured to receive one or more signals (such as an output signal of 12 volts direct current) from the control subsystem. The motion assembly may further include a gear assembly 42 having one or more gears and one or more shafts connected to the clamping assembly. For example, the gear assembly may include a pinion gear, a driven gear, a valve driver, and a valve adapter, as shown in FIG. 4.

Manual override assembly 38 may include any suitable structure configured to disconnect the gear(s) and/or one or more shaft(s) of the gear assembly from the motor(s) and to allow a user to manually rotate the clamped valve stem. In some examples, the manual override assembly may include an override shaft movable between a motor driven position and a manual operation position, as shown in FIGS. 6-7. In the motor driven position, the override shaft may be disconnected from the clamping assembly allowing the motion assembly to move the clamped valve stem through the clamping assembly. In the manual operation position, the override shaft may be connected to the clamping assembly and the gear assembly may be disconnected from the motor(s) allowing a user to move the override shaft (such as using a wrench) to move the clamped valve stem through the clamping assembly.

For example, a driven gear may include a square aperture configured to receive the override shaft. The override shaft may include a first portion having a square cross-section sized to be received in the square aperture of the driven gear, and a second portion having a round cross-section smaller than the first portion. In the motor driven position, the override shaft may have its first portion received in the square aperture of the driven gear and the square aperture of a valve driver.

To move the override shaft to the manual operation position, a user may press the override shaft toward the driven gear, which may move the second portion of the override shaft to be received in the square aperture of the driven gear disengaging the driven gear from the valve driver. A spring or other bias element may be configured to urge the override shaft to the motor driven position. When the motor drives the pinion gear and the driven gear, the square aperture of the driven gear will line up with square cross-section of the first portion of the override shaft allowing the spring to move the override shaft to the motor driven position.

In some examples, the override shaft may visually indicate its current position. For example, the override shaft may be in an up position when in the motor driven position and may be in a down position relative to the up position when in the manual operation position, or vice-versa. Alternatively, or additionally, the manual override assembly may include any suitable mechanism to visually communicate to a user whether the override shaft is in the motor driven position or the manual operation position.

Control subsystem 26 may include any suitable structure configured to receive signal(s) from the sensor subsystem and to control operation of the motor(s) of the valve actuator assembly based on the received signal(s). The control subsystem may communicate with the sensor subsystem and/or the valve actuator assembly via one or more communication linkages, which may be wireless or wired for one-way or two-way communication.

The control subsystem may, for example, include a controller assembly 44 and one or more load sensor(s) 46. Controller assembly may include a controller, which may have any suitable form, such as a computerized device, software executing on a computer, an embedded processor, programmable logic controller, an analog device, and/or functionally equivalent devices. Additionally, the controller may include any suitable software, hardware, and/or firmware. In some examples, the controller assembly may include any suitable memory in electrical communication with the controller. The load sensor(s) may be configured to detect the current demand of the motor(s). Although the controller assembly and load sensor(s) are shown to be discrete components, the controller assembly may, in some examples, include the load sensor(s) and/or incorporate the functionality of those sensors. In some examples, the control subsystem may include a transmitter/receiving assembly 48 configured to receive one or more signals from the transmitting assembly of the sensor subsystem and/or transmit one or more signals to the valve actuator assembly.

Although the sensor subsystem is described to be connected wirelessly to the control subsystem and the valve actuator assembly is described to have a wire connection to the control subsystem, the sensor subsystem may alternatively, or additionally, be connected via a wire connection to the control subsystem and/or the valve actuator assembly may alternatively, or additionally, be connected to the control subsystem wirelessly. When the valve actuator assembly is connected to the control subsystem wirelessly, the control subsystem may include a transmitting assembly configured to transmit one or more signals to the valve actuator assembly, and the valve actuator assembly may include a receiving assembly configured to receive one or more signals from the valve actuator assembly. Additionally, the valve actuator assembly may include a power source for the motor (such as battery(ies), solar panel(s), electrical plugs, etc.) allowing for wireless activation of the motor by the control subsystem.

The control subsystem may be configured to operate the motor(s) of the valve actuator assembly based on the received signal(s) from the sensor subsystem in any suitable way(s). For example, when the control subsystem receives a signal from the sensor subsystem, the control subsystem may automatically operate the motor(s) in response to receiving the signal. Alternatively, or additionally, the control subsystem may compare the measured and/or detected parameter(s) with one or more predetermined values (such as values stored in memory of the control subsystem) to determine if it should operate the motor(s). For example, the control subsystem may determine if the measured and/or detected parameter(s) are more than, less than, or equal to a predetermined value, or outside or within a predetermined range of values.

The control subsystem may be configured to operate the motor(s) in any suitable way(s). For example, the control subsystem may operate the motor(s) based on current and/or voltage demand from the motor(s). When the control subsystem operates or runs the motor(s), there may be an inrush demand initially, followed by a normal demand that relates to normal valve operation, a full load demand as the valve is near and/or at the closed position, and then a stall demand as the valve reaches a hard stop of the piping system. Although some current or voltage demand profiles may be relatively flat within each phase of operation, other current or voltage demand profiles may not be flat (such as having one or more ramps) within one or more phases of operation may be used as a basis by the control subsystem to operate the motor(s).

In some examples, the control subsystem may detect when the demand of the motor(s) is more than a predetermined maximum demand or outside a predetermined range of demands, such as more than the full load demand or outside the range between normal demand and full load demand, and then shut off the motors in response to detecting the excessive demand.

In some examples, control subsystem may detect the time that the motor(s) are in particular demand(s), such as the time that the motor(s) are in a no load demand, and/or the time that the motor(s) are in the normal demand and/or full load demand. The control subsystem may be configured to stop operating the motor(s) after a predetermined time duration (which may be stored in memory). The predetermined time duration may, for example, be the expected time for the valve to be moved from a first position to a second position, such as a fully open position to a fully closed position. For example, the control subsystem may be configured to stop operating the motor(s) after one minute of detecting a no load demand, which may indicate that the clamping assembly is not attached to the valve or that the valve is broken.

In some examples, the predetermined time duration may be based on the type of valve that is attached to the clamping assembly. The control subsystem may include a selector switch or selector mechanism configured to allow a user to select which type of valve is attached to the clamping assembly, such as whether the valve is a ball valve or a gate valve. Alternatively, a particular control subsystem may be configured for a specific type of valve and a kit of control subsystems may be provided for each type of valve.

For example, when a ball valve is attached to the clamping assembly, the predetermined time duration to turn the ball valve from a first position to a second position, such as a quarter turn (to move from a fully open position to a fully closed position), may be about 35 seconds. The control subsystem may be configured to shut off the voltage signal to the motor(s) after the predetermined time duration, such as within 0.5 seconds. When a gate valve is attached to the clamping assembly, the predetermined time duration to move the gate valve from a first position to a second position, such as a fully open position to a fully closed position (which may involve multiple turns of the valve stem), may be about 138 seconds. The control subsystem may be configured to shut off the voltage signal to the motor(s) after the predetermined time duration. Although particular time durations are mentioned for specific valve types, other time durations may be used by the control subsystem.

In some examples, control subsystem may have a learn mode that determines the appropriate predetermined time duration for the particular valve that is attached to the clamping assembly. The learn mode may be used during start-up and/or during testing of the control subsystem. For example, the control subsystem may direct the user to attach the clamping assembly to the valve with the valve in the fully open position and/or other suitable position(s). The control subsystem may run the motor(s), determine the time for the motor(s) to move the valve to a fully closed position and/or other suitable position(s), and store that time as the predetermined time duration for later use. In some examples, the control subsystem may direct the user to verify that the valve is in the fully open position and/or fully closed position. In some examples, the control subsystem may request that the user run the learn mode at regular intervals to recalibrate the subsystem, such as by visual and/or audio alerts.

Other examples of valve actuator assembly 24 are shown in FIGS. 2-9. Although some of the examples in the present disclosure refer to automatic valve actuator systems that are configured to move a valve from a fully open position to a fully closed position upon detection and/or measurement of one or more variable(s) and/or parameter(s), the automatic valve actuator systems may alternatively, or additionally, be configured to move a valve from a fully closed position to a fully open position, from a normal closed position to a normal open position, from a normal open position to a normal closed position, and/or between first and second positions.

The automatic valve actuator systems of the present disclosure may include one or more of the following:
A system that works with existing plumbing—no requirement to break into the piping to put in an actuator specific piece of plumbing.
A system that includes one or more clamping structured that attach to the valve stem with the valve handle removed.
A system that includes one or more connectors that attach to the existing handle of the valve
A system that includes one or more flexible connectors that attach to the valve to allow for minor misalignment of actuator and valve, which can be a flex drive cable or a set of rigid components configured to allow defined relative motion between parts.
A mounting assembly that attaches directly to an adjacent wall (e.g., floor, ceiling).
A mounting assembly that has reaction supports to allow alternate mounting orientations (pipes with pipe flanges).
A control assembly configured to use current draw or back emf of the actuator drive motor to ascertain the state (or position) of the valve (hard stop at closed, hard stop at full open, varying electrical requirements at other conditions).
A control assembly having a processor and a memory. The processor including a learn mode that will differentiate and saves, in the memory, the type of valve onto which the actuator is installed (e.g., the control assembly knows that the attached valve is a ball valve based on the elapsed time from movement of the valve from the open position toward the closed position until the hard stop is reached vs. amount of time for a gate valve to spin many turns to the closed position or open position).
A control assembly configured to reverse movement of the valve just enough to unload the backlash of the gear train to take the load off the drive mechanism to allow an easy activation of the manual override shaft.
A control assembly configured to periodically cycle the valve to prevent a valve from seizing over time from corrosion or seal set.
A control assembly configured to receive a command signal for actuation via wireless and/or wired communication from remote sensors or logic (e.g., water sensors, earthquake sensor protectively closing valves).

The disclosure set forth above encompasses multiple distinct inventions with independent utility. While each of these inventions has been disclosed in its preferred form, the specific embodiments thereof as disclosed and illustrated herein are not to be considered in a limiting sense as numerous variations are possible. The subject matter of the inventions includes all novel and non-obvious combinations and subcombinations of the various elements, features, functions and/or properties disclosed herein. Similarly, where any claim recites “a” or “a first” element or the equivalent thereof, such claim should be understood to include incorporation of one or more such elements, neither requiring nor excluding two or more such elements.

Inventions embodied in various combinations and subcombinations of features, functions, elements, and/or properties may be claimed through presentation of new claims in a related application. Such new claims, whether they are directed to a different invention or directed to the same invention, whether different, broader, narrower or equal in scope to the original claims, are also regarded as included within the subject matter of the inventions of the present disclosure.

What is claimed is:

1. An automatic actuator apparatus for a manual valve, comprising:
a sensor assembly configured to detect a condition and transmit a sensor signal indicating detection of the condition;
a valve actuator assembly configured to be attached to the manual valve and to move the manual valve between open and closed positions; and
a control assembly configured to receive the sensor signal and to transmit a first control signal to the valve actuator assembly based, at least in part, on the sensor signal, wherein the valve actuator assembly is further configured to receive the first control signal from the control assembly and to move the manual valve toward the closed position in response to receiving the first control signal.

2. The automatic actuator apparatus of claim 1, wherein the valve actuator assembly includes:
a gear assembly configured to be attached to the manual valve; and
a motor operatively connected to the gear assembly to move the manual valve from the open position toward the closed position.

3. The automatic actuator apparatus of claim 2, further comprising a manual override assembly configured to disconnect the motor from the gear assembly to allow a user to move the manual valve between the open and closed positions.

4. The automatic actuator apparatus of claim 2, wherein the control assembly is further configured to detect a force that would prevent the manual override assembly from disconnecting the motor from the gear assembly and that is applied by the gear assembly to the manual valve when the manual valve is moved by the gear assembly to one of the open and closed positions.

5. The automatic actuator apparatus of claim 4, wherein the control assembly is configured to send a second control signal based, at least in part, on detecting the force, wherein the valve actuator assembly is configured to receive the second control signal from the control assembly and to move the manual valve a sufficient amount toward the other of the open and closed positions to remove the force.

6. The automatic actuator apparatus of claim 2, wherein the valve actuator assembly further includes a connector assembly configured to connect the gear assembly and the manual valve, the connector assembly being configured to be attached to the manual valve.

7. The automatic actuator apparatus of claim 6, wherein the connector assembly is configured to be attached to a valve handle of the manual valve.

8. The automatic actuator apparatus of claim 7, where the manual valve is a ball valve, and wherein the connector assembly is configured to be attached to a valve handle of the ball valve.

9. The automatic actuator apparatus of claim 7, where the manual valve is a gate valve, and wherein the connector assembly is configured to be attached to a valve handle of the gate valve.

10. The automatic actuator apparatus of claim 1, wherein the valve actuator assembly and the control assembly are in wired communication with each other.

11. The automatic actuator apparatus of claim 10, wherein the sensor assembly and the control assembly are in wireless communication with each other.

12. The automatic actuator apparatus of claim 1, wherein the sensor assembly is configured to detect the presence of water.

13. The automatic actuator apparatus of claim 1, wherein the control assembly is configured to send a third control signal to the valve actuator assembly at predetermined time intervals, the valve actuator assembly being configured to receive the third control signal from the control assembly and to move the manual valve between open and closed positions in response to receiving the third control signal.

14. A valve actuator and control apparatus for a manual valve, comprising:
a valve actuator assembly configured to be attached to the manual valve and to move the manual valve between open and closed positions, the valve actuator assembly including:
a gear assembly configured to be attached to the manual valve; and
a motor operatively connected to the gear assembly; and
a control assembly configured to receive a sensor signal and to transmit a control signal to the valve actuator assembly based, at least in part, on the sensor signal, wherein the valve actuator assembly is further configured to receive the control signal from the control assembly and to move the manual valve toward the closed position in response to receiving the control signal.

15. An automatic actuator apparatus for a manual valve, comprising:
a sensor assembly configured to detect water and transmit a sensor signal indicating detection of water;
a valve actuator assembly including:
a gear assembly configured to be attached to the manual valve, and
a motor operatively connected to the gear assembly and configured to move the manual valve between open and closed positions;
a control assembly configured to receive the sensor signal and to transmit a control signal to the motor based, at least in part, on the sensor signal, wherein the motor is further configured to receive the control signal from the control assembly and to move the manual valve toward the closed position in response to receiving the control signal; and
a manual override assembly configured to disconnect the motor from the gear assembly to allow a user to move the manual valve between the open and closed positions.
